(19) United States
(12) Patent Application Publication
(10) Pub. No.: US 2009/0305794 A1
(43) Pub. Date: Dec. 10, 2009

(54) Automatic Resetting Mechanical Torque Limiting Clutch

(76) Inventors: Thomas F. Long, JR., Wichita Falls, TX (US); Jason Alan Clemans, Wichita Falls, TX (US); Mark Wayne Rudolph, Wichita Falls, TX (US)

Correspondence Address: JOHN R. BENEFIEL, 525 Lewis Street, BIRMINGHAM, MI, 48009, US

(21) Appl. No.: 12/481,701

(22) Filed: Jun. 10, 2009

Related U.S. Application Data
(60) Provisional application No. 61/060,288, filed on Jun. 10, 2008.

(51) Int. Cl. F16D 7/02

(52) U.S. Cl. 464/48

(57) ABSTRACT

A resettable torque limiter for installation between two rotary members, which can smoothly disengage upon application of a predetermined torque acting between the members and smoothly reset upon decline of applied torque below the predetermined level. An undulating cam surface formed on one member is engaged by one or more cam followers on the other member which smoothly ride over undulation peaks comprising cam lobes when the torque limit is exceeded and the driving connection between the rotary members is interrupted until the applied torque declines below the preset limit.

### CROSS REFERENCE TO RELATED APPLICATIONS

This application claims the benefit of U.S. provisional application No. 61/060,288 filed on Jun. 10, 2008.

### BACKGROUND OF THE INVENTION

This invention concerns automatically resetting torque limiting clutches and more particularly automatically resetting torque limiters which can disconnect on overload.

Resetting torque limiting clutches have been in existence for many years, typically of a friction clutch or ball detent type. The friction type will release or slip at a preset overload torque value, and will reengage when the overload is removed. The disadvantage of this arrangement is that repeated heating of the torque limiter friction linings (as heat is generated the slipping) causes the clutch capacity to fade, as the higher lining temperatures reduces the coefficient of friction, until the torque limiter slips continuously and destroys itself.

Another long known torque limiter type is the ball-detent reset torque limiter, which uses spring forces to push balls into drill point cavities with the geometry thereof establishing forces and angles to produce a release at a preset torque level. The torque limiter will reengage when the torque demand falls somewhere below the release torque. The disadvantage of this device is the sudden changes in the acceleration of the connected components, which produces shock loads on the components when running disengaged, or when reengaging, which produces high stresses and deformations which greatly reduce the torque limiter service life.

It is an object of the present invention to provide an automatically resetting torque limiting clutch in which a connected drive member can run with the torque limiter in a released condition without overheating or imposing shock loads during normal operation or when an overload causes relative rotation between driving and driven members.

### SUMMARY OF THE INVENTION

The above recited object and others which will be understood by those skilled in the art upon a reading of the following specification and claims are achieved by an automatic resetting torque limiting clutch acting between two rotary members which transmits torque through one or more cam followers carried by one rotary member urged into contact with a cam surface carried on the other rotary member. The cam followers transmit forces to the cam surface which has a smoothly continuous undulating shape which provides a displacement curve for the cam followers to trace so that there are no abrupt acceleration changes imparted to the cam followers as they are displaced by the cam undulations. The cam followers are prevented from overrunning the cam undulation peaks or lobes by spring arrangements producing an engagement pressure and increasing forces resisting displacement of the cm followers by the cam surface contour preventing the cam followers from passing over the cam lobes until a predetermined torque level is applied by the driving member whereupon the cam followers are able to overcome the forces and be displaced sufficiently to overrun the cam lobes and thereby interrupt the transmission of torque through the torque limiter.

The development of forces necessary to produce the displacement of the cam followers sufficient to release the torque limiter can be set to a selected characteristic providing the release and also the reengagement performance characteristics required. Harmonic motion characteristics, cyclodial motion characteristics and eighth-power polynomial motion characteristics can be used alone or in combinations. Acceleration and velocity curves are matched so that “jerk” is not infinite at any point in the cycle.

The cam undulation peaks or cam lobes are located radially out from the axis of rotation of the members in order to transmit torque by the engagement of the cam followers and the cam surface but can be arranged to undulate either radially or axially to generate the displacement resisting forces exerted on the cam followers in contact therewith. The undulation can also be formed on internal or external surfaces.

The cam followers may be mounted in various ways, including on rocker arm assemblies carried by a driving or driven member so as to engage and follow the cam surface and generates forces transmitting the driving torque to the driven rotary cam member. The arrangement can be reversed so that the cam member is the driver and the cam followers are on the driven member.

Other arrangements include radial slides having cam follower rollers on the ends thereof or rollers rotatably mounted on radially extending pins carried on an axially movable ring urged to engage the rollers with an axially varying cam surface.

The typical driving load for the reset torque limiter would be about one third to one half the torque release settings for the limiter. The normal “drive torque to release torque ratio” can be varied or adjusted by changes to the cam displacement curve.

A cam-follower automatic resetting torque limiting clutch according to the invention can be manufactured in various designs depending on application requirements.

### DESCRIPTION OF THE DRAWINGS

FIG. 1 is a pictorial view of a first embodiment of a torque limiter according to the present invention with an outer rotary member shown in phantom lines to reveal interior details.

FIG. 2 is an enlarged fragmentary side view of a portion of the torque limiter shown in FIG. 1.

FIG. 3A is a pictorial view of a rotary cam member included in the torque limiter of FIG. 1.

FIG. 3B is a pictorial view of a different embodiment of the rotary cam member shown in FIG. 3A.

FIG. 3C is a pictorial view of another embodiment of the rotary cam member shown in FIG. 3A.

FIG. 4A is a pictorial view of a cam follower assembly in engagement with a fragmentary portion of a rotary cam member.

FIG. 4B is another pictorial view of the cam follower assembly in engagement with a fragmentary portion of a rotary cam member.

FIGS. 5A and 5B are pictorial views of the cam follower assembly and rotary cam member from different angles.

FIG. 6 is a pictorial view of another embodiment of the torque limiter incorporating a rotary cam member having an internal cam surface.

FIG. 7A is an end view of another embodiment of a rotary cam member having an axially varying cam profile.

FIG. 7B is a pictorial view of the axially varying cam member shown in FIG. 7A.

FIG. 7C is a fragmentary pictorial view of the components of a torque limiter incorporating a rotary cam member as shown in FIGS. 7A and 7B.

FIG. 7D is an end view of components of the torque limiter shown in FIG. 7C.

FIGS. 7E-1 and 7E-2 are two different sectional views through a torque limiter incorporating the components shown in FIGS. 7A-7D.

FIG. 8 is a pictorial view of an embodiment of torque limiter according to the invention incorporating an external rotary cam member and rocker arm followers with a particular rocker arm spring mounting arrangement.

FIG. 9A is an exploded pictorial view of components of a rocker arm cam follower incorporating an internal spring arrangement.

FIG. 9B is a pictorial view of the rocker arm assembly shown in FIG. 9A.

FIG. 9C is an end view of the rocker arm assembly shown in FIGS. 9A and 9B.

FIGS. 10A and 10B are fragmentary views in different positions of a torque limiter using the rocker arm assembly shown in FIGS. 9A-9C.

FIG. 11 is an end view of an embodiment of torque limiter according to the invention incorporating the internal rocker arm springs shown in FIGS. 9A-9C and 10A and 10B.

FIG. 12 is an enlarged sectional view of a rocker arm assembly incorporating a built in lubricating oil pump.

FIG. 13 is a sectional view through a rocker arm incorporating a built in centrifugal oil pump.

FIG. 14A, 14B are partially sectional, partially diagrammatic views of a direct drive torque limiter according to the invention.

FIG. 15A and 15B are partially sectional, partially diagrammatic views of an indirect drive torque limiter according to the invention.

FIGS. 16A and 16B are diagrams of the force relationship between an external cam and follower cam roller in normal operation and release conditions.

FIG. 17 is a pictorial view of a preferred embodiment of an axially cammed torque limiter according to the invention.

FIG. 17A is a fragmentary pictorial sectional view of a variation of the torque limiter shown in FIG. 17.

FIG. 18 is an enlarged view of a portion of FIG. 17A showing details thereof.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

A radially acting external cam torque limiter 10 is shown in FIG. 1.

The automatically resetting torque limiter 10 includes two rotary members 12, 14. One member 12 is formed with a cam surface 16, which extends circumferentially about the axis of rotation of the member 12. The cam surface 16 in this embodiment undulates to form one or more peak undulations or cam lobes 16A, the distance from the axis of rotation to points on the cam surface varying about the outer perimeter of the member 12.

The other rotary member 14 mounts one or more cam follower assemblies 18 including rolling engagement elements comprising rollers 20 spring urged into engagement with the cam surface 16 with a radially inwardly directed force which increases as the rollers 20 move up a cam lobe 16A. As long as the torque level transmitted between the members 12, 14 is below a predetermined release torque, the spring force prevents the rollers 20 from completely ascending the peaks undulation or cam lobes 16A since the spring force resisting movement of the rollers increases as the rollers 20 move up the cam lobe 16A until the applied torque can no longer generate sufficient force to further displace the roller 20.

A rotary driving connection is therefore maintained acting between the cam surface 16 and the rollers 20, and is there is no relative rotation therebetween and the driving relationship between the cam surface 16 and followers 18 is maintained (except for a very minor relative motions due to drive torque variations). This is because the radially directed spring force will prevent movement of the rollers 20 all the way up the cam lobe 16A, preventing relative rotation until the cam follower rollers 20 can rotate past the lobes 16A on the cam surface 16 which occurs when the applied torque becomes sufficiently high to overcome the spring force.

The reaction force between the cam follower rollers 20 and the cam surface 16 produces a tangential component capable of generating a torque if the members do not rotate relative to each other. This relative rotation is prevented as long as the torque level generates a radial or axial component not sufficiently high to be able to move the cam follower elements 20 completely past the peak undulations or cam lobes 16A. That is resisting spring the torque must be high enough to develop a force component able to overcome the urging force and force the cam follower to move a sufficient distance in a direction away from the cam surface to clear the cam lobes 16A against the resistance of the urging spring force acting on the cam follower rollers in opposition to the torque generated component.

Once that torque level is exceeded, the cam follower rollers 20 will overcome the spring force and completely ascend and move past the respective peak undulations 16A on cam surface 16, and relative rotation between the members 12, 14 continue as long as the applied torque remains at or above that level. If the torque level declines below that predetermined level, drive is automatically re-established between the members 12, 14 as the follower rollers 20 can no longer completely ascend the cam surface peak undulations or lobes 16A due to the resistant of the spring forces. The displacement of the cam followers 18 produced by the curve of the cam surface 16 produces smooth, continuous accelerations of the rollers 20 when ascending the undulations 16A, which avoids shocks when the torque limiter 10 is running released or when resetting.

The moving parts may be submerged in an oil bath, the oil held outward by centrifugal force, and heat from churning the oil when the torque limiter 10 in a released state is thereby dissipated to air.

The cam follower assemblies 18 and cam surfaces 16 may be variously configured and mounted.

The cam surface shape can be varied to accommodate any number of cam follower assemblies as required to produce the required release torque level, with one lobe for each cam follower. The cam surface shape can also be varied to produce high torque attack, i.e., resistance to radial or axial movement of the cam followers 18 can be made to increase rapidly when ascending the lobes 16A and a lower rate of torque decline when descending the cam lobes 16A.

The cam surface 16 can be on the exterior perimeter of the rotary member 12 with the cam follower rollers 20 moving radially outwardly against inwardly directed spring forces to release as shown in FIG. 1, or a cam surface 17 can be formed on an internal surface, with the cam follower rollers 20 spring urged to move radially outwardly as seen in FIG. 6 to engage the internal surface.

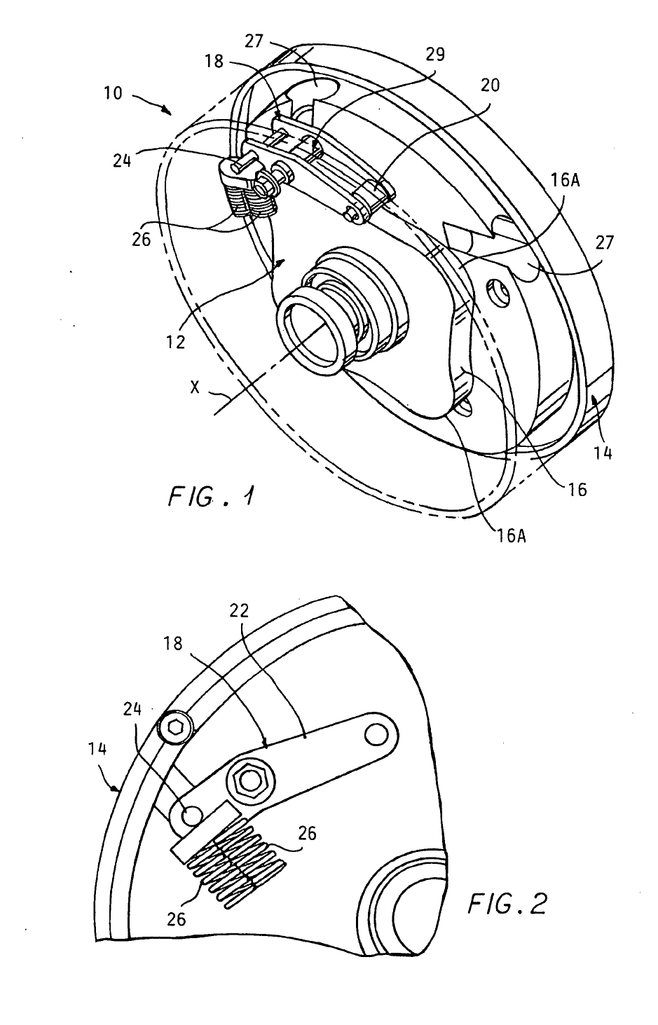

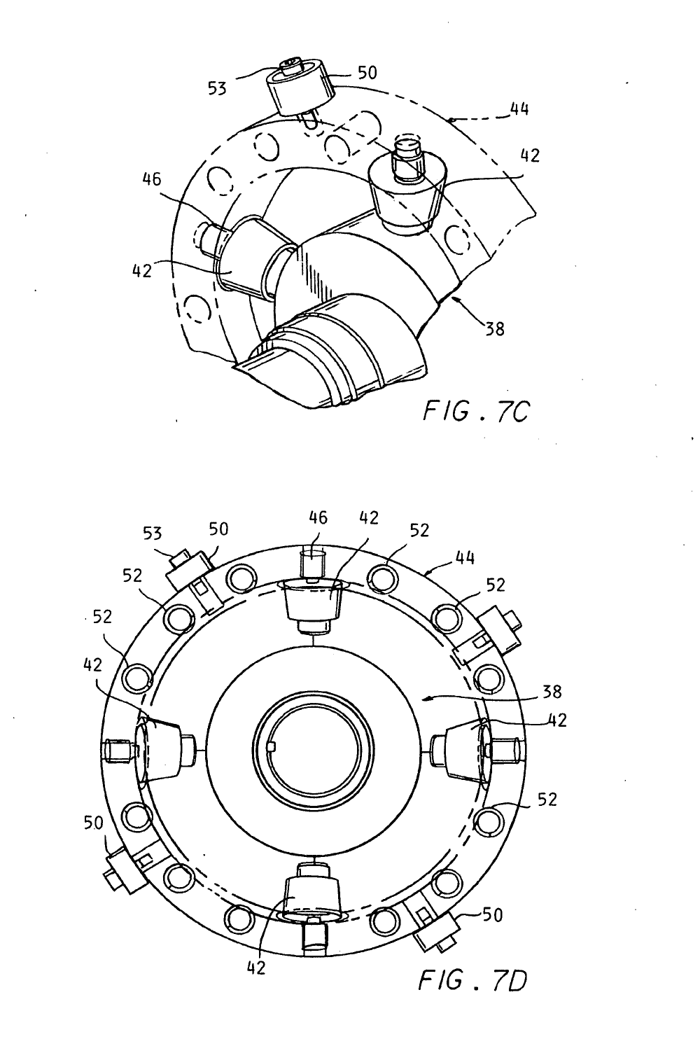

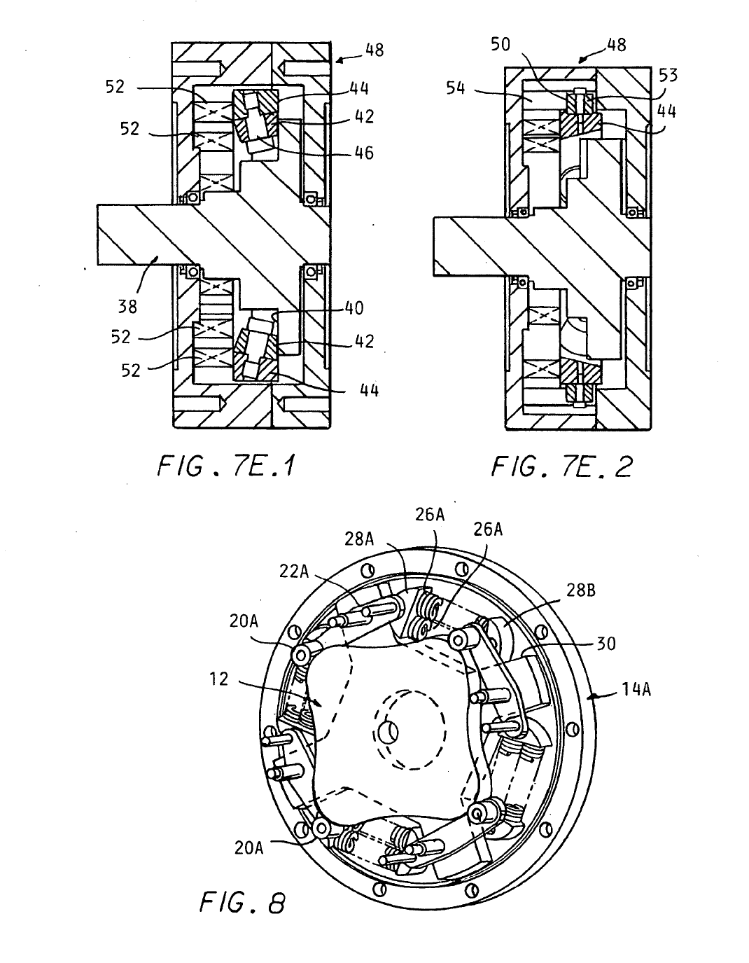

The cam surface can also be formed on an axial face of a cam member 12A with the cam follower rollers 20 cammed to move axially as in the embodiments of FIGS. 7A through 7E-2 described further below.

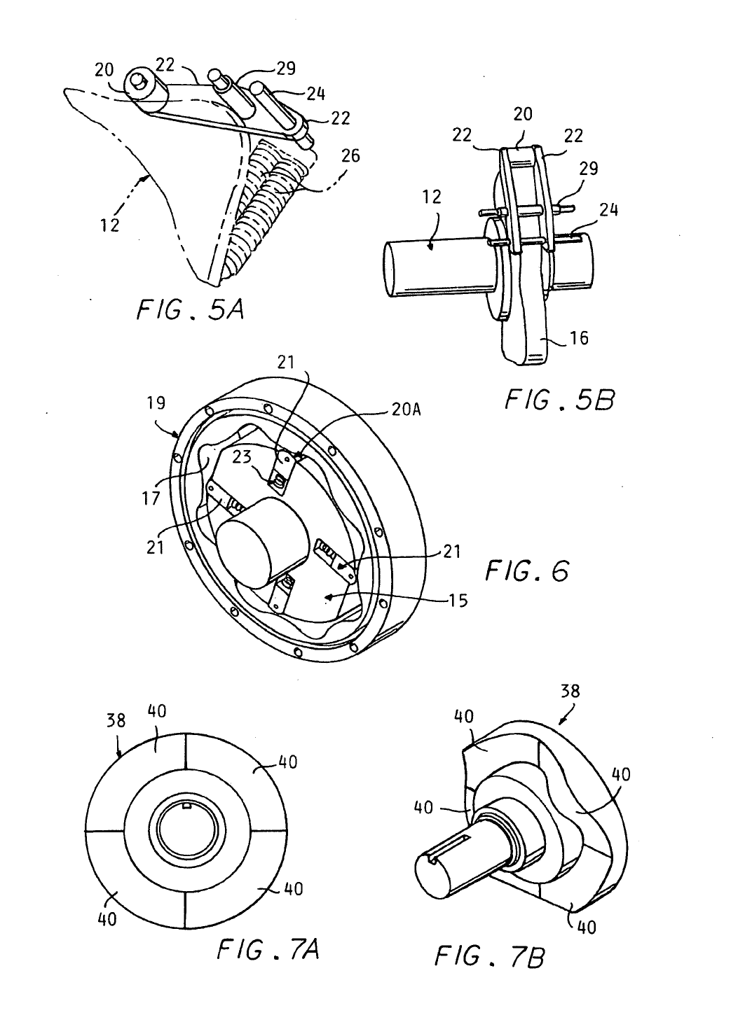

In the embodiment of FIGS. 1-5, one rotary member 12 comprises a rotor having a peripherally extending external cam surface 16 as described above, and the cam followers 18 each include a roller 20 mounted on one end of a pair of rocker arms 22 pivotally mounted on the other rotary member 14 with pivot pin assemblies 29.

The other rotary member 14 is formed in an annular shape which encloses the rotary member 12. The other end of each of the pivoted rocker arms 22 mounts a cross pin 24 which acts to compress a pair of springs 26 disposed in spring seat cavities 27 formed in the member 14. The rocker the arms 22 pivot up as the cam follower rollers 20 are moved radially outwardly in ascending the cam surface lobes 16A but are unable to completely pass over the cam lobes 16A until the transmitted torque exceeds a predetermined level.

FIG. 8 shows an alternate mounting for the rocker arm springs 26A in which the springs 26A extend generally tangentially to the axis of rotation of the member 14, and are compressed by pivoting of the rocker arms 22A pushing half round end pieces 28 together, with a stop feature 30 preventing the far end piece 28 from moving away so that compression of the springs 26A occurs upon outward movement of the rollers 20. Other spring configurations can also provide the resisting urging forces on the cam follower rollers 20A, which establishes the transmitted torque.

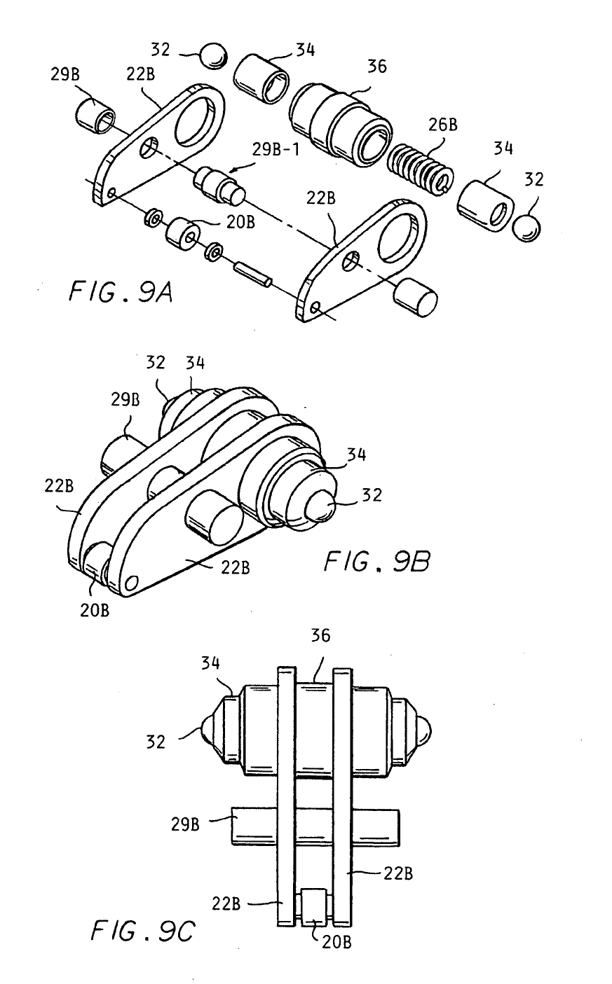

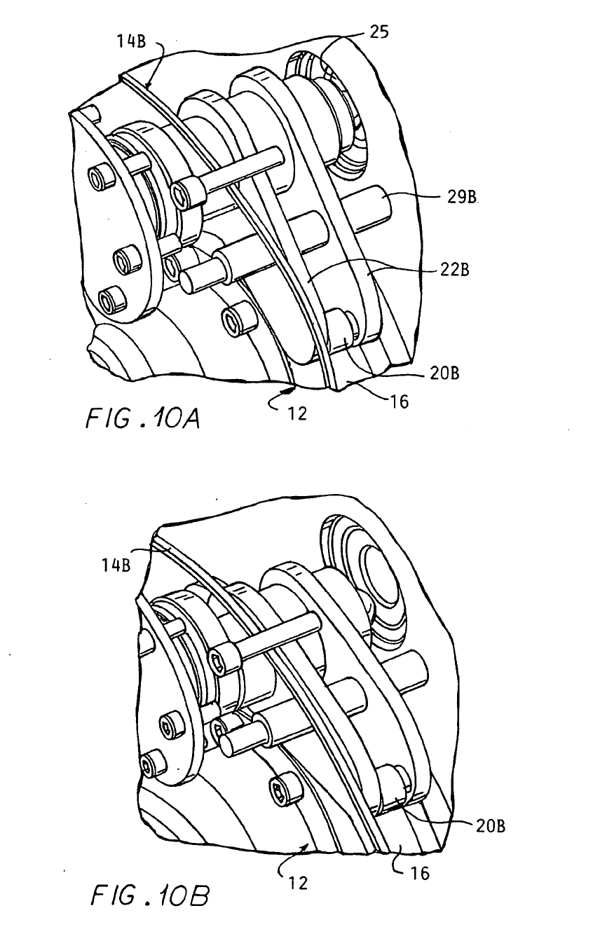

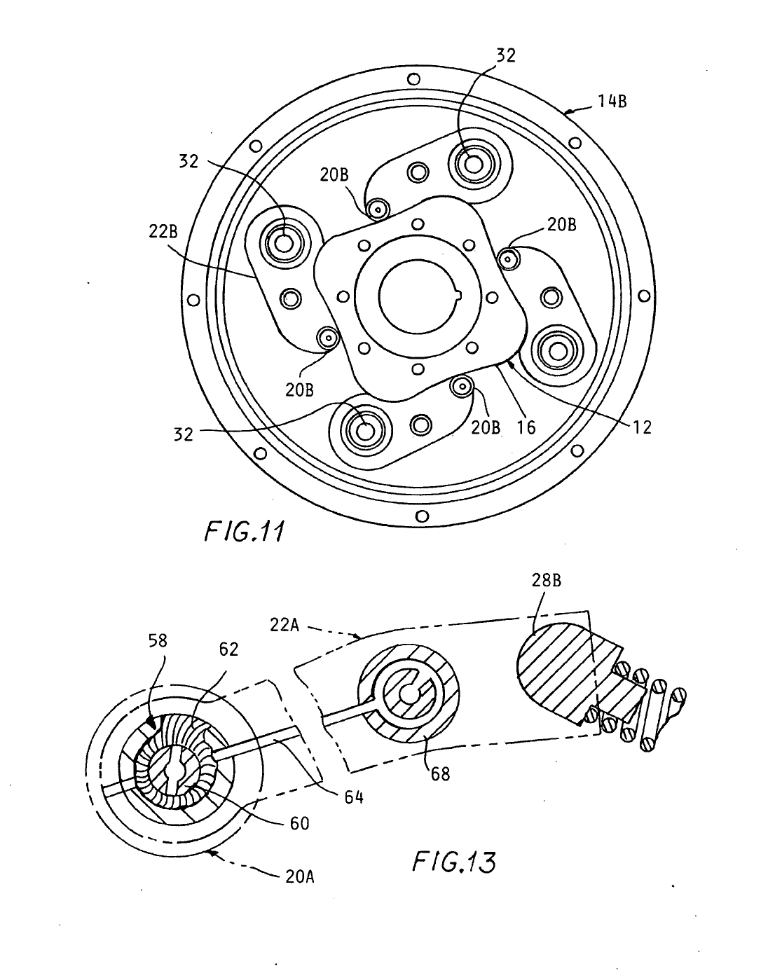

Another cam follower configuration is shown in FIGS. 9A-9C and 10A, 10B. This configuration minimizes the space required. The springs 26B force balls 32 along an axis parallel to the axis of pivoting of the rocker arm 22B. The balls 32 are seated in conical stepped recesses 25 (specifically designed detents), which increasingly compress the springs 26B as the balls 32 are moved up the recess stepped surfaces to be cammed out as the rocker arms 22B are pivoted.

The rocker arms 22B are pivoted by engagement of the cam follower rollers 20B with the cam lobes 16A formed on the member 12. The rocker arms 22B are pivotally mounted on the outer rotary member 14B by pivot pin 29B-1 held with caps 29B.

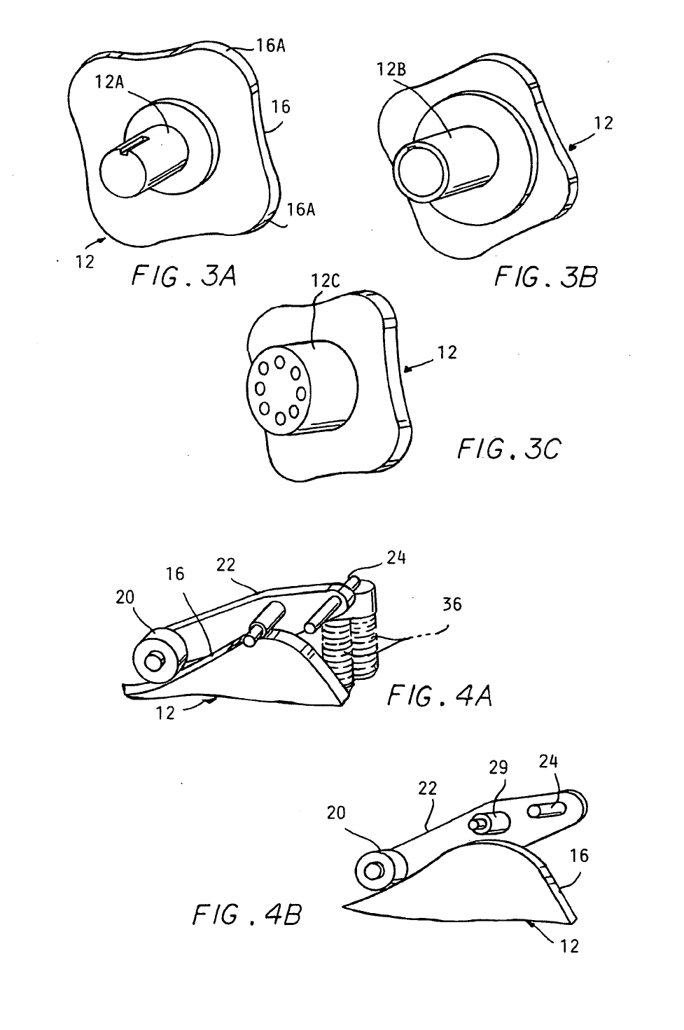

As seen in FIGS. 3A, 3B and 3C, various alternate mountings of the drive member 12 are shown. In FIG. 3A, an integral shaft can be keyed or splined to an input or output member. In FIG. 3B an integral tube 12B can be keyed or splined to an input or output shaft. In FIG. 3C, threaded holes are formed in an integral shaft to allow attachment of a flange to connect a sheave, gear, etc.

In the embodiment of FIG. 6, the annular outer rotary member 19 has a circumferentially undulating cam surface 17 on the inside of a cavity, and inner rotary member 15 carries cam followers comprised of sliders 21 having rollers 20A rotatably mounted on the ends thereof, the sliders 21 movable radially in slots formed in the rotary member 15 and urged radially outwardly by springs 23 into engagement with the cam surface 17.

In the embodiment of FIGS. 7A through 7E-2, the cam surface on a rotary member 38 has cam lobes 40 projecting in an axial direction (FIGS. 7A, 7B), although located spaced radially out from the axis of rotation in order to generate a torque. Tapered cam follower rollers 42 (FIGS. 7C-7E-1) are mounted on a spring ring 44 carried on another rotary member 48. The tapered rollers 42 are mounted for rotation about radial axes defined by axle pins 46, and are urged axially into engagement therewith by a set of springs 52 acting in an axial direction on the spring ring 44. Guide rollers 50 are mounted on pins 53 projecting radially from the spring ring 44.

The guide rollers 50 move in slots 54 (FIG. 7E-2) in the other rotary member 48 so as to cause the spring ring 44 to rotate with rotary member 48 while freely allowing relative axial movement thereof necessary to axially displace the spring ring 44 by engagement of the rollers 42 with lobes 40.

The driving and driven rotary members are held to be concentric with each other by frictionless bearings (usually ball bearings or tapered roller bearings if thrust forces are applied.) Bearings can be oil or grease lubricated. During the driving mode the entire bearing assembly rotates as a unit with no relative rotation between races so as to not require lubrication. For oil lubrication, the bearing mounting may provide dams which hold oil in the bearings against centrifugal forces.

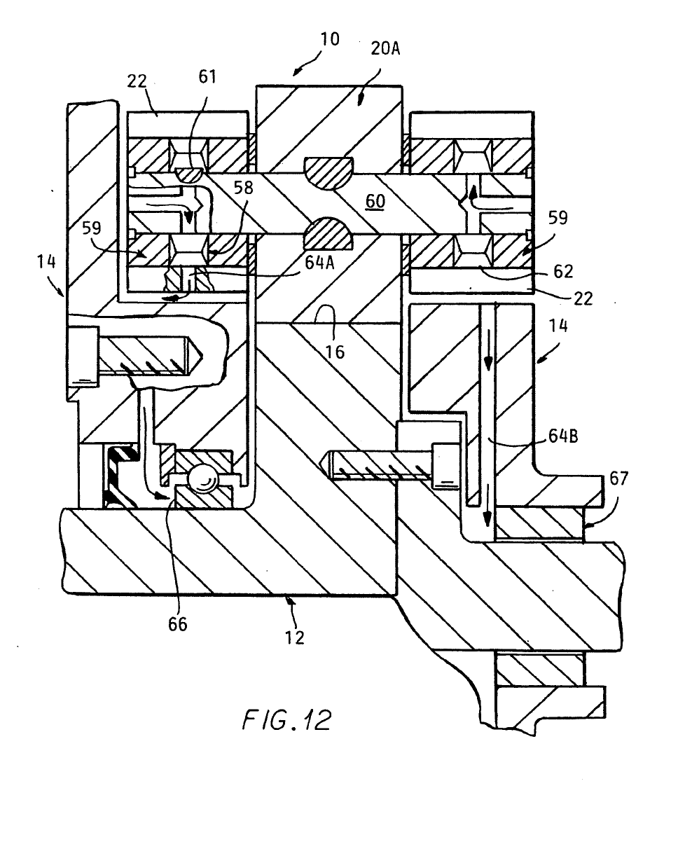

As seen in FIGS. 12 and 13, oil for the main bearings, in the center of the torque limiter 10, is pumped from the oil annulus at the outer portion of the torque limiter assembly by small centrifugal pumps 58 mounted within bearings 59 on each end of the pins 60 for the rollers 20A. The pumps 58 are built into the rocker arms 22 and are driven by the rotation of the rocker arm cam rollers 20A which occurs only upon relative rotation. The cam follower roller 20A rotates, driven by (or driving) the engagement with the cam surface 16 when the torque limiter 10 is overrunning in an overload condition. At this time the main bearings begin to function and may require lubrication. Each cam follower roller 20A drives its attached pin 60 which in turn drives the pump rotors 62. Oil is conveyed to the bearings 66, 67 and other parts by internal drillings 64.

If rotational speeds are high and the torque limiter is disengaged, the temperature of the oil will rise above ambient and may exceed the heat rejection rate of the torque limiter. Internal wireless sensors or external fixed sensors (not shown) may provide the high temperature signal.

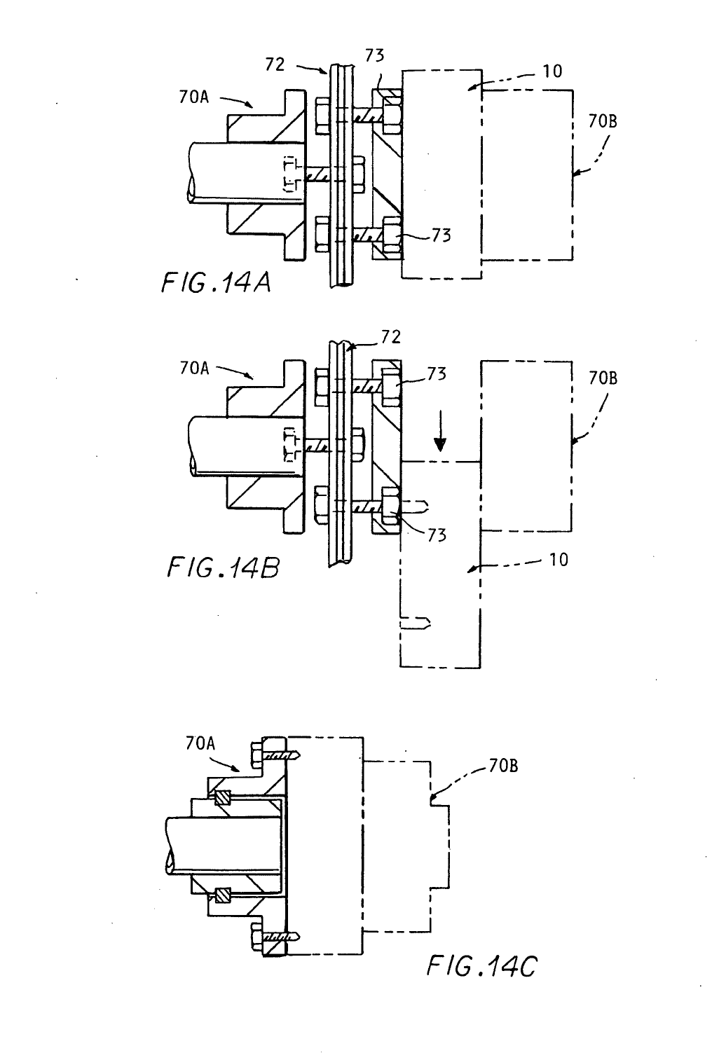

For inline mounting, the torque limiter 10 may be mounted on the input or output shaft 70A, 70B of the drive as seen in FIGS. 14A-14C. A flexible coupling 72 is required to provide for shaft misalignment.

FIGS. 14A-14C also show a “drop out” mount, in which the torque limiter 10 can be slipped out after removal of bolts 73 as indicated. This eliminates the need to completely disassemble the drive line to remove or replace the torque limiter 10.

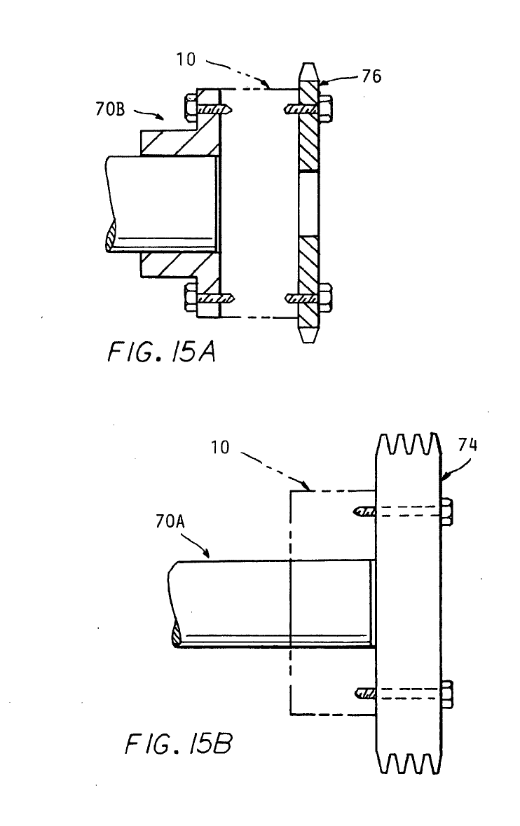

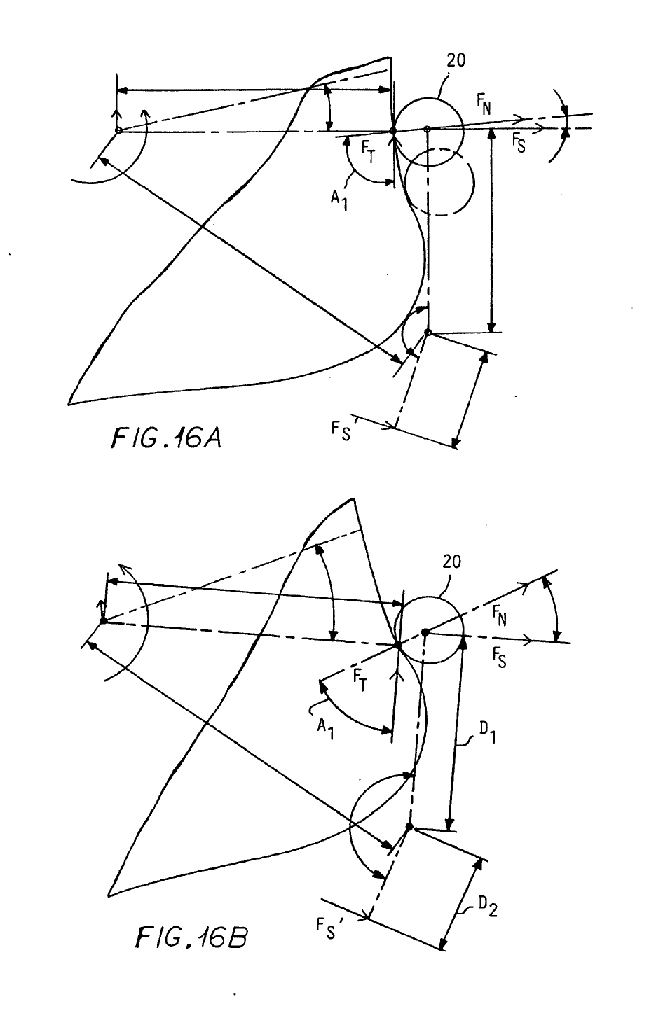

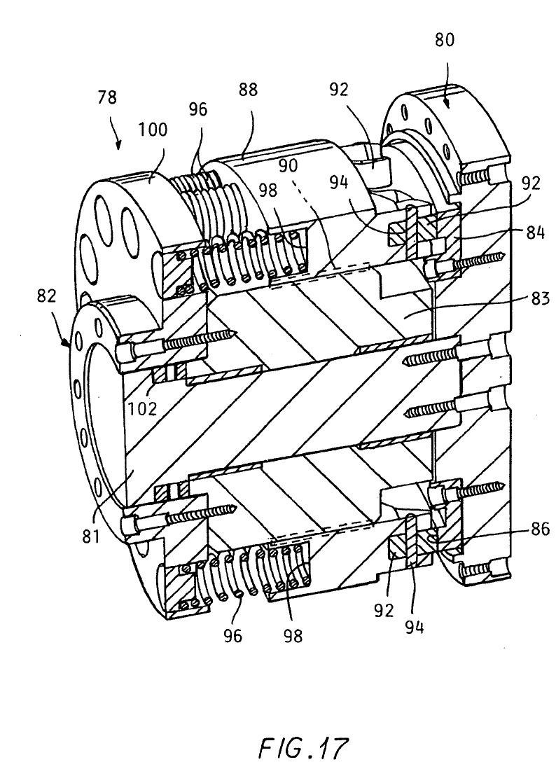

For indirect drives, sheaves 74, sprockets 76 or gears etc., can be mounted on the input or output members of the torque limiter as required. (FIGS. 15A, 15B)

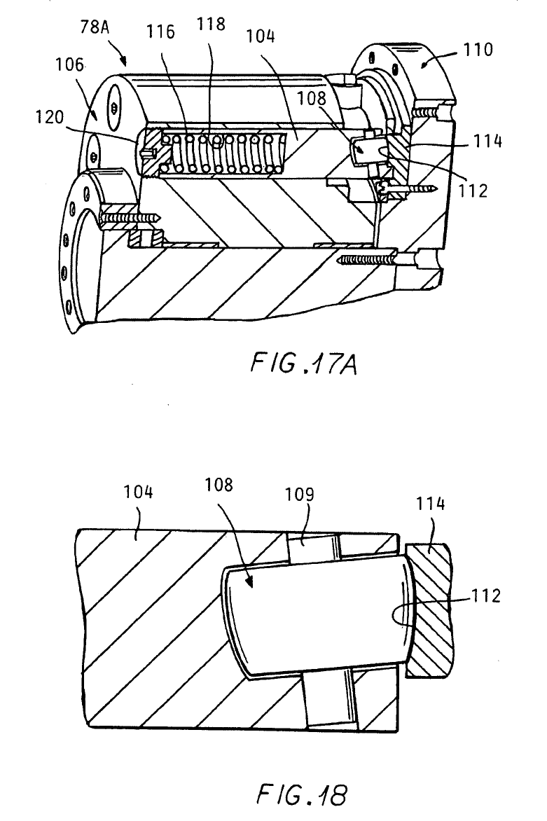

FIGS. 16A and 16B diagram the forces generated in a driving condition transmitting low torque (16A) and high torque (16B). As torque is applied to the cam member the follower element begins to roll up the undulation increasingly compressing the spring through the rocker arm. The force of the spring (F_{S}) keeping the cam follower in constant contact with the cam surface (through the rocker arm) causes a reaction force (F_{N}) normal to the cam surface. A component of (F_{N}) acting perpendicular to a radial line to the point of contact is shown as (F_{T}). The magnitude of (F_{T}) multiplied by the radial distance to the point of contact is the torque transmitted by the follower. The magnitude of (F_{T}) increases as the follower rolls further up the cam undulation due to the increased spring compression combined with the increased pressure angle between (F_{N}) and the radial line to the point of contact. As the magnitude of (F_{T}) increases and the radial distance between (F_{T}) and the axis of rotation increases, the transmitted torque increases until it equals the input torque. When an over torque situation occurs and the cam follower rolls up and over the cam lobe 16A, the torque transmitted drops until the follower encounters the next lobe 16A on the cam in a continuous cycle.

Referring to FIG. 17, a preferred form of the axially varying cam surface torque limiter 78 is shown.

An input flange 80 and input shaft 81 and output member 82 and output shaft 83 are drivingly connected by interengagement of a cam ring 84 formed with axial undulations 86 located radially outward from the axis of rotation of the assembly. The input flange 80 and cam follower carrier ring 88 have a splined connection 90 therebetween so that the output member 82 and carrier ring 88 can have relative axial movement while maintaining a rotary connection therebetween.

The carrier ring 88 mounts a plurality of cam follower rollers 92 mounted on radial axle pins 94.

The rollers 92 are urged into axially undulating cam surface 86 by a series of compression springs 96 contained in pockets 98 in the carrier ring and an output member flange 100.

A thrust bearing 102 absorbs the axial thrust generated by the springs 96 and follower rollers 92.

FIG. 17A shows a variation 78A of the axial torque limiter 78 which includes a series of axially extending pistons 104 mounted in individual pockets 118 in the cam follower member 106. A cam follower tapered roller 108 pivoted on pins is disposed in a slot in the end of each of the pistons 104 and is urged to engage undulating surfaces 112 formed on a cam ring 108 fixed to the cam member 110. Each piston is urged in an axial direction by a compression spring 116 also installed in each pocket 118 in the cam follower 106 and adjustably compressed with threaded plugs 120 received in the ends of pockets 118. FIG. 18 shows that each roller 108 is of preferably of a tapered generally barrel shape although having partially spherically curved sides and cam surface 112 is correspondingly shaped. The rollers 108 are each mounted on a pin 119 installed after insertion of the roller 108 in the slot in the end of the respective piston 104. This configuration minimize the axial length of the pistons and the torque limiter. A piston 104 for each undulation cam lobe balances the axial forces around the axis of the torque limiter 78A.

The torque limiters are adjustable and provide variable release torque settings. This is accomplished by varying the number of cam followers or by adjusting the spring forces applied to the rocker arms or other cam follower element supports.

1. A torque limiter arrangement for interrupting a rotary drive between two rotary members comprising:
an undulating cam surface formed on one rotary member extending around an axis of rotation of said one member having one or more peaks each comprising a cam lobe;
one or more respective cam followers carried by another of said rotary members including an engagement element spring urged into contact with said cam surface by a spring arrangement acting on said engagement element, producing an increasing resistance force as said element is caused to ascend a respective cam lobe by relative rotation between said members until the torque applied by one of said rotary members is insufficient to overcome said to establish a driving connection between said rotary members force and wherein when a transmitted torque increases so as to cause said cam follower elements to be moved over said cam lobes whereby a rotary driving relationship between said sufficient to move said cam followers past said cam lobes, said rotary driving relationship between said rotary members will be interrupted until said applied torque again declines sufficiently to reset said torque limiter and re-establish a rotary driving relationship between said rotary members.

2. The torque limiter according to claim 1 wherein said cam surface undulates in a radial direction and said urging of said one or more cam follower elements is in a radial direction.

3. The torque limiter according to claim 1 wherein said cam surface undulates in an axial direction and said one or more follower elements are urged in an axial direction by said spring arrangement to be engaged with said cam surface.

4. The torque limiter according to claim 2 wherein said cam surface undulates about an outside perimeter of said one rotary member and said cam follower element is urged radially inward into engagement with said cam surface by said spring arrangement.

5. The torque limiter according to claim 2 wherein said cam surface undulates about an interior perimeter wall of said one rotary member and said cam follower element is urged in a radially outward direction into engagement with said cam surface by said spring arrangement.

6. The torque limiter according to claim 1 wherein said each of said one or more cam follower elements comprise a roller rotatably mounted on a support so as to be rotated by engagement with said cam surface upon relative rotation between said rotary members.

7. The torque limiter according to claim 6 wherein said cam surface undulates in a radial direction and said urging of said one or more cam follower elements by said spring arrangement is in a radial direction.

8. The torque limiter according to claim 7 wherein each respective roller support comprises a rocker arm having a pivotal mount to said other rotary member with a roller rotatably mounted on a one end of said rocker arm, and wherein said spring arrangement comprises one or more springs arranged to act on another end of said rocker arm tending to move a respective roller thereon in a radial direction by movement about said pivotal mount.

9. The torque limiter according to claim 6 wherein said cam surface undulates in an axial direction and said one or more cam follower elements are urged in an axial direction to be engaged with said cam surface by said spring arrangement.

10. The torque limiter according to claim 9 wherein each of said roller supports comprises a slide disposed in a radial slot in said one rotary member, each slide having said roller mounted on an outer end thereof, and a spring urges each of said slides radially outward.

11. The torque limiter according to claim 9 wherein said roller support comprises a spring ring axially movable on said other rotary member while maintaining a rotary driving connection therebetween, said spring ring having one or more rollers mounted on radially extending axle pins, each roller being tapered and engaging a respective axial undulation formed on said one member and extending about an axis of rotation thereof under the urging of axially acting springs urging said spring plate in an axial direction.

12. The torque limiter according to claim 8 wherein each of said rocker arms comprises two rocker arm sides with said roller mounted therebetween at one end.

13. The torque limiter according to claim 12 wherein a cross pin extends across said other end of said rocker arm with protruding ends engaged by one or more of said springs.

14. The torque limiter according to claim 12 further including a lubricant pump associated with a rocker arm operated by rotation of said roller to circulate lubricating oil in said torque limiter.

15. The torque limiter according to claim 1 wherein said cam lobes are defined by gently curving surfaces extending in either direction from a peak thereof.

16. The torque limiter according to claim 1 wherein a plurality of cam lobes are formed on said one of said rotary members and a corresponding number of cam follower elements are carried by said another of said rotary members.

17. The torque limiter according to claim 3 wherein said cam followers comprise axially moveable pistons each carrying a roller at one end and urged to be engaged with said axially undulating cam surface by a spring arrangement acting on another end of each piston.

18. The torque limiter according to claim 3 wherein said cam followers comprise axially moveable pistons each carrying a roller at one end and urged to be engaged with said axially undulating cam surface by a spring arrangement acting on another end of each piston wherein each piston and spring are received in a packet formed in said cam follow member.

19. The torque limiter according to claim 11 wherein said cam followers comprise axially moveable pistons each carrying a roller at one end and urged to be engaged with said axially undulating cam surface by a spring arrangement acting on said spring ring wherein each of said cam follower rollers is tapered.

20. The torque limiter according to claim 11 wherein said cam followers comprise axially moveable pistons disposed in a respective pocket formed in said spring ring, each piston carrying a roller at one end and urged to be engaged with said axially undulating cam surface by a spring acting on another end of each piston wherein each cam follower roller has a partially spherical sides and wherein each spring is adjustably compressed by a plug threaded into said respective pockets.
